(19) United States
(12) Patent Application Publication
(10) Pub. No.: US 2017/0132551 A1
(43) Pub. Date: May 11, 2017

(54) SYSTEMS AND METHODS OF PRIORITIZING PRODUCTS DURING UNLOADING OF DELIVERY VEHICLES

(71) Applicant: Wal-Mart Stores, Inc., Bentonville, AR (US)

(72) Inventors: Daniel R. Shields, Rogers, AR (US); Matthew A. Jones, Bentonville, AR (US); Nicholaus A. Jones, Fayetteville, AR (US); Marc A. Fletter, Bentonville, AR (US); Robert J. Taylor, Rogers, AR (US)

(21) Appl. No.: 15/342,758

(22) Filed: Nov. 3, 2016

Related U.S. Application Data
(60) Provisional application No. 62/251,356, filed on Nov. 5, 2015.

(51) Int. Cl. G06Q 10/06; G06Q 50/28; G06Q 30/02

(52) U.S. Cl. CPC G06Q 10/06315; G06Q 30/0202; G06Q 50/28

(57) ABSTRACT

In some embodiments, apparatuses and methods are provided herein useful to prioritize products while unloading. In some embodiments, systems comprise: a product scanner system configured to scan products; a product prioritization system comprising a control circuit that executes instructs to: receive the first product identifier information of the first product being unloaded from the delivery vehicle; obtain a demand rating of the first product that corresponds to a current sales floor demand; confirm the demand rating has a predefined relationship with a sensitivity override threshold of the shopping facility that corresponds to a product stocking workload to be performed at the shopping facility; and associate, during an unloading process, the first product with a first priority tier when the demand rating of the first product has the predefined relationship to the sensitivity override threshold and has a predefined relationship relative to a first product demand threshold.

### CROSS-REFERENCE TO RELATED APPLICATION

This application claims the benefit of U.S. Provisional Application No. 62/251,356, filed Nov. 5, 2015, and is incorporated herein by reference in its entirety.

### TECHNICAL FIELD

This invention relates generally to product inventory.

### BACKGROUND

In a modern retail environment, there is a need to improve the customer service and/or convenience for the customer. One aspect of customer service is the products being on the sales floor of a shopping facility and readily available for customers. Reduced sales often occur as a result of products being understocked on the sales floor.

### BRIEF DESCRIPTION OF THE DRAWINGS

Disclosed herein are embodiments of systems, apparatuses and methods pertaining to providing notification of product priority as workers are unloading products from a delivery vehicle. This description includes drawings, wherein:

FIG. 1 shows a simplified block diagram of an exemplary priority system of a shopping facility, in accordance with some embodiments.

FIG. 2 illustrates a simplified block diagram of an exemplary product prioritization system that is utilized in at least some priority systems, in accordance with some embodiments.

FIG. 3 illustrates a simplified flow diagram of a process of prioritizing products being unloaded from a delivery vehicle at a shopping facility and providing a notification of product priority, in accordance with some embodiments.

FIG. 4 illustrates a simplified flow diagram of a process of providing notification of product priority, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to distribute products from a received shipment at a shopping facility. In some embodiments, a system provides notification of product priority. This priority can be provided as products are being removed from a truck or other shipment method. In some instances, a product scanner system scans products being unloaded from a delivery vehicle at the shopping facility. The scanning obtains a product identifier of each product scanned. The product identifier is communicated from the scanner to a product prioritization system. The product prioritization system includes a control circuit coupled to memory that stores computer instructions to be executed by the control circuit. The control circuit receives the product identifiers of the scanned one or more products that are being unloaded from the delivery vehicle and a corresponding demand rating of each the products is identified. In some implementations, the demand ratings of the products correspond to a current sales floor demand of the corresponding product at the time the one or more products are being unloaded. The control circuit can confirm the demand rating of a product has a predefined relationship with a sensitivity override threshold of the shopping facility. In some embodiments, the sensitivity override threshold corresponds to a product stocking workload to be performed at the shopping facility. Based on the evaluation of the demand rating and during the unloading process, the product is associated with a priority tier when the demand rating of the corresponding product has the predefined relationship to the sensitivity override threshold and has a predefined relationship relative to a first product demand threshold.

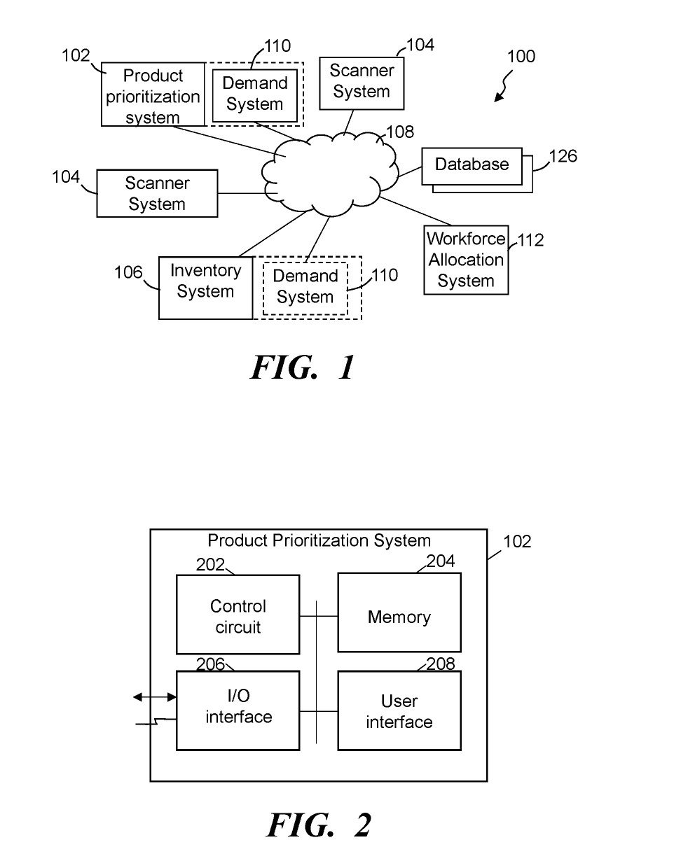

FIG. 1 shows a simplified block diagram of an exemplary priority system 100 of a shopping facility, in accordance with some embodiments. The priority system 100, in part, provides notifications of product priorities to workers at the shopping facility as the workers are unloading a delivery of products from a delivery vehicle at the shopping facility. The shopping facility may be any type of shopping facility at a location in which products for display and/or for sale are variously distributed throughout the shopping facility space. The shopping facility may be a retail sales facility, or any other type of facility in which products are displayed and/or sold. The facility may be any size of format facility, and may include products from one or more merchants. For example, a facility may be a single store operated by one merchant or may be a collection of stores covering multiple merchants such as a mall.

The priority system 100 includes a product prioritization system 102, one or more product identifier and/or scanner systems 104 (referred to below generally as scanner systems), an inventory system 106, and a communication network 108. The system typically further includes and/or is in communication with a workforce allocation system 112. Some embodiments further include and/or couple with a product demand system 110. The product prioritization system 102 receives product identifier information from a scanner system and based on the identified product determines whether the product is to be prioritized relative to stocking the product on the sales floor of the shopping facility. In some embodiments, the product prioritization system 102 may be implemented through a central computer system of the shopping facility that in part determines product priorities.

Typical unloading processes of delivery vehicles (e.g., trucks, vans, etc.) includes workers unloading the entire product load of the vehicle all at once. Further, in such typical unload processing, the products, pallets of a product or products, and/or cases of products (generally referred to below as “products”) are further unloaded while each product is assumed to have the same level of priority. The products once unloaded may be sorted by shopping facility department, by aisle or some other level of granularity. The products are then transported to the sales floor according to the intended department and/or aisle location within the shopping facility without consideration of product priority. The stocking on the sales floor most often does not occur until later in the evening, when most customers are done shopping for the day and the overnight stocking occurs with reduced interference to customers. The results with such stocking, however, causes products that otherwise could be stocked immediately, due in part to availability on the sales floor and/or due to demand on the sales floor, to not actually be stocked until the middle of the night when sales have already been lost.

According to some present embodiments, however, the product prioritization system 102 determines prioritizes of products as they are being unloaded from a delivery vehicle or just after they are unloaded and prior to being sorted (e.g., by department, location within the store, etc.). The prioritization is dependent in part on the product demand on the sales floor at the time the product is being unloaded. The demand of the product, however, is further considered in view of a sensitivity override threshold of the shopping facility that corresponds in part to at least a product stocking workload to be performed at the shopping facility. Typically, even though there may be a significant demand for one or more products, the shopping facility is limited based on the availability of workers and/or the demands being placed on workers. As such, some embodiments further take into consideration workload associated with stocking one or more products to the sales floor and/or other tasks that are assigned and/or expected to be assigned to workers. In some implementations, the workforce allocation system 112 provides relevant workforce information, such as but not limited to maximum available workforce to perform restocking, preferred workforce available to perform restocking, scheduled and/or predicted workforce availability, tasks assigned and/or corresponding workforce allocation to assigned and/or scheduled tasks, and the like. This workload can further be evaluated, in some applications, relative to an available workforce at the shopping facility and/or scheduled or predicted to be at the shopping facility, the work tasks already assigned to the workforce, scheduled work tasks, one or more priority levels of those previously assigned and/or scheduled tasks, and other such factors.

Utilizing this information, one or more sensitivity override thresholds of the shopping facility can be defined, in part to try and ensure that workforce is not overly emphasized on the unloading and stocking of products, which may adversely affect the workforces' ability to support customers and perform other tasks. For example, tasks at the shopping facilities may be assigned task priorities, and these task priorities may vary depending on time of day, time between similar tasks performed, and the like. As such, the sensitivity override threshold may be determined as a function of the stocking needs at the shopping facility. For example, other tasks may be lowered in priority and/or stocking may be increased in priority such that the sensitivity override threshold is adjusted based on a reallocation of available workforce. Further, in some embodiments, the prioritization system may override one or more assigned and/or scheduled tasks based on determined product demand and/or demand rating of one or more products being unloaded. This override can further takes into consideration a priority of other tasks, the product demand, expected and/or scheduled workforce, and the like.

In performing the unloading, the workers performing the unloading can utilize the product scanner systems 104 to scan one or more identifiers and/or codes of the products being unloaded. The scanner system may maintain product identifier information local on each scanner system and/or may communicate with the inventory system 106 to communicate scanned identifier information that allows the inventory system to identify the products and provide the identifier information to the product prioritization system 102, or return the product identifier information to the scanner system that communicates the information to the product prioritization system and/or worker.

In some implementation, for example, the product scanner system 104 can be used to scan an identifier associated with a product, packaging, case, pallet or the like. For example, the scanner system can optically scan an optically scannable bar code, or other such optically scannable identifier on each of one or more products being unloaded from the delivery vehicle at the shopping facility. Additionally or alternatively, some embodiments may include RFID tag scanners or readers, cameras, other such scanners or detectors or combinations of two or more of such scanners detectors. The product identifier information of each scanned product is obtained, and in some instances may be communicated to the inventory system. In other implementations, the product identifier information may be obtained from the inventory system. Once the identifier information is obtained, it can be communicated to the product prioritization system 102. The product identifier information may, for example, be optical bar code information, while in other instances, may include a unique identifier, may include product size, quantity and/or other relevant information that may be used to distinguish the product from other products. The one or more scanner systems may be mobile units that can be carried by workers to easily scan products (e.g., bar codes). In some implementations, one or more of the scanner systems may be implemented through a software application (APP) stored and executed and a workers personal user interface unit (e.g., smart phone, tablet, etc.). A camera of the user interface unit or other scanner system can be used to capture an image of the optical code and image processing implemented to obtain relevant product identifier information. In other instances, the scanner system may be a special purpose device that includes scanning capabilities (e.g., laser bar code reader).

The inventory system 106 is configured to track inventory of the thousands, tens of thousands or more products available through the shopping facility. The inventory information is continuously being updated based in part on product sales, received shipments, throw-aways, and other such factors. Accordingly, the inventory system is typically coupled with a point of sale system that includes multiple point of sale units (e.g., registers at the shopping facility, on-line sales, etc.). Further, shipment information and/or delivery load information is provided to the inventory system to update inventory information based on products received at the shopping facility.

The demand system 110 may be a stand-alone system or may be part of the product prioritization system 102 and/or the inventory system 106. Typically, the demand system communicationally couples with the product prioritization system 102 (e.g., through the communication network 108) and is configured to provide product demand information to the product prioritization system. Additionally, in some implementations, the demand system is configured to use product inventory information in determining sales floor product demand for the one or more products scanned during the unloading of the delivery vehicle. Further, in some instances, the demand system can obtain and may utilize information from the inventory system and/or a point of sales system regarding rates of sales of products of interest in determining a sales floor demand. The rate at which a product is selling and/or is predicted to sell (e.g., based on historic sales, recent sales trends and rates, and the like) may be used, in some applications, to predict quantities that will be sold by one or more threshold time periods (e.g., expected time to get product unloaded and restocked on a sales floor shelf, changes based on modifications to workers assigned tasks, and the like). Utilizing this information the demand system 110 is configured to determine a sales floor demand for the products at the time the products are being unloaded from the delivery vehicle.

Some embodiments may additionally or alternatively utilize product location information in determining sales floor demand and/or shopping facility demand. For example, when there are products in a back storage area, the demand system can take these into account. In some applications the demand system can distinguish between products on the sales floor versus products not on the sales floor (e.g., identify that the only product in the store is in a back storage area, and thus conclude that the shelf on the sales floor is empty). Further, the current demand may take into consideration the rate of sales and the predicted reduction in product on the sales floor based on the expected rate of sale. In some applications, the rate of sales can be associated with one or more weights that are applied to a determined current demand and/or demand rating to provide an adjusted demand rating. Additionally or alternatively, one or more threshold may be adjusted based on the expected sales and/or rate of sales. In some embodiments, the demand system includes the systems and/or implements some or all of the processes described in International Application No. PCT/US2015/042781 filed Jul. 30, 2015, entitled SYSTEMS AND METHODS FOR DEMAND TRACKING IN A RETAIL ENVIRONMENT, and U.S. Provisional Application No. 62/030,909, filed Jul. 30, 2014, entitled SYSTEMS AND METHODS FOR DEMAND TRACKING IN A RETAIL ENVIRONMENT, which are incorporated herein by reference.

The demand system may further take into consideration an amount of shelf, rack, floor space, and the like that are out on the sales floor and that are intended to be used by the product being evaluated in determining a sales floor demand based on an available and/or empty space into which the product can be placed. In some instances, a delivery load identifier is obtained (e.g., based on a scan or other identifier of a delivery inventory sheet). The demand system may further utilize this information to determine on-floor demand while and/or prior to many of the products being unloaded from the delivery vehicle. As such, the demand at the time of unload can readily be determined and provided to the product prioritization system 102.

Further, in some implementations, the demand system 110 and/or the product prioritization system 102 use the product demand and/or sales floor demand of a product being unloaded and evaluated to determine and/or specify a demand rating of products being considered. These demand ratings typically correspond to one or more threshold levels of demand (which can take into consideration rates of sales and/or predicted rates of sales). For example, some embodiments may specify a first product to a first demand level when a shelf demand on the sales floor in the shopping facility for the first product is greater than or equal to a first demand threshold (e.g., a shelf capacity) on the sales floor for the first product. Accordingly, this level can correspond to when a shelf space for the product is substantially empty of the product. As such, there is a need to get product to the shelf. Additionally as introduced above, the demand may be greater than the available shelf space, based on rates of sales and expected potential sales when the product is available for purchase.

Some embodiments may further specify the demand rating of a product to a second demand level when the shelf demand of the product on the sales floor is greater than a shelf capacity threshold of the product. The shelf capacity threshold can correspond to a percentage of shelf capacity (e.g., 50%, 70%, 80%; of shelf capacity, or the like). The shelf capacity threshold may be set based on one or more factors, such as but not limited to rate of predicted sales, historical sales rate, expected amount of time to move product to restock the shelf, or other such factors, and typically a combination of two or more of such factors. As such, the shelf capacity threshold may correspond to a level or product on the shelf that corresponds to a desire to get product moved out to the shelves. Further, this shelf capacity threshold may vary over time (e.g., based on changing rates of demand, based on changing predicted rates of demand, and the like). Similarly, some embodiments may employ more than one sales capacity thresholds that correspond to different demand ratings.

In some implementations, the demand rating of a product may be specified as or set to a third demand level when the shelf demand has a predefined relationship with a third demand threshold, such as demand being predicted to be less than the shelf capacity threshold of that product and is further predicted to be greater than a full case of the product. In such a demand rating, the quantity of product on the shelf is greater than the shelf capacity threshold; however, there is sufficient available shelf space to receive at least a full case of the product being evaluated. As such, at least a full case can be moved out to the sales floor with confidence that a full case can be fully stocked without leaving one or more individual products that have to be moved back to the storage area of the shopping facility and binned, which can take time and adversely affect restocking efficiencies. Other demand ratings can be specified according to one or more other threshold levels.

The product demand system 110 may further be configured to identify a statistical demand determined as a function of current demands of multiple different products available for purchase at the shopping facility. This statistical demand may, in some applications, be configured as a store level statistical demand that corresponds to an overall product demand on the sales floor for the shopping facility. Again, the statistical demand may be determined based on one or more predefined and/or selected products that may be representative of different categories or products. These preselected products may be determined through tracking of historical sales and/or demands of products relative to categories, departments and/or store level. The statistical demand may be determined, for example, as a mean of product demand for multiple products. Additionally or alternatively, some embodiments determine a demand median of multiple different products. Further, the statistical demand may take into consideration anomalies, statistical outlines (e.g., outside a selected number of standard deviations), additional effects on demand (e.g., sales, weather, other events, etc.), and other such information that can be statistically evaluated in tracking, determining and/or predicting demand. This statistical demand can be relevant in setting the sensitivity override threshold because it can reflect an overall demand for products in the shopping facility and/or within certain departments of the shopping facility, which can indicate a need to allocate workforce, a representation of a lack of available workforce and other such factors. As such, the sensitivity override threshold can be assigned as a function of the statistical demand. In some implementations, the sensitivity override threshold corresponds to and/or defines how aggressively the prioritization system want to pick products being unloaded and force products to the sales floor. As the sensitivity override threshold setting is increased, it is more likely that more picking will result because it is more likely that a greater number of products meet the sensitivity override threshold to force a priority and thus force a pick.

FIG. 2 illustrates a simplified block diagram of an exemplary product prioritization system 102 that is utilized in at least some priority systems 100, in accordance with some embodiments. The product prioritization system 102 determined and notifies workers of a product priority as the product is removed from a delivery vehicle. This allows products with higher priorities to more quickly get to the sales floor over products with less priority and/or demand. The product prioritization system 102 includes a control circuit 202, memory 204, and one or more input/output (I/O) interfaces 206. In some implementations, the product prioritization system includes one or more user interfaces 208 configured to allow users to interact with the product prioritization system to provide relevant information to the product prioritization system and/or obtain the product prioritization.

In some embodiments, the control circuit 202 comprises one or more processors and/or microprocessors. The control circuit couples with and/or includes the memory 204. Generally, the memory 204 stores the operational code or one or more sets of instructions that are executed by the control circuit 202 and/or processor to implement the functionality of the product prioritization system. In some implementations, the memory further stores code, instructions and corresponding data to prioritize products and/or communicate with other components of the system. Such data may be pre-stored in the memory or be received, for example, from an inventory system 106, demand system 110, scanner systems 104, workforce allocation system 112, other sources, or combinations of such sources.

It is understood that the control circuit may be implemented as one or more processor devices as are well known in the art. Further, the control circuit may utilize remote processors dispersed over a distributed communication network (e.g., LAN, WAN, Internet, etc.). Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 204 is shown as internal to the launch pad control system; however, the memory 204 can be internal, external or a combination of internal and external memory. Similarly, the memory may be dispersed over a distributed communication network. Additionally, the product prioritization system 102 includes and/or couples with a power supply (not shown) and/or it may receive power from an external source.

In some instances, the control circuit 202 and the memory 204 may be integrated together, such as in a microcontroller, application specification integrated circuit, field programmable gate array or other such device, or may be separate devices coupled together. In some applications, the control circuit 202 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

The one or more I/O interfaces 206 allow wired and/or wireless communication coupling of the product prioritization system 102 to external components, such as the scanner systems 104, inventory system 106, demand system 110, and other such components. Accordingly, the I/O interface 206 may include any known wired and/or wireless interfacing device, circuit and/or connecting device, such as but not limited to transceivers, receivers, transmitters, and the like. For example, in some implementations, the I/O interface 206 provides wireless communication in accordance with one or more wireless protocols (e.g., cellular, Wi-Fi, Bluetooth, radio frequency (RF), other such wireless communication, or combinations of such communications).

In some embodiments the product prioritization system may include and/or couple with one or more user interfaces 208. The user interface can include substantially any known input device, such one or more buttons, knobs, selectors, switches, keys, touch input surfaces, scanners, displays, etc. Additionally, the user interface may include one or more output display devices, such as lights, visual indicators, display screens, etc. to convey information to a user, such as product priority, threshold information, inventory information, product information, product identifiers, notifications, errors, conditions and/or other such information. While FIG. 2 illustrates the various components being coupled together via a bus, it is understood that the various components may actually be coupled to the control circuit 202 and/or one or more other components directly.

In some embodiments, the control circuit 202 of the product prioritization system 102 is configured to receive the product identifier of one or more products being unloaded from the delivery vehicle. A demand rating can be obtained and/or identified for each of the one or more products being unloaded from the delivery vehicle. As described above, the demand rating may be determined by the product prioritization system 102 and/or the demand system 110. Further, in some implementations the demand rating of each of the products corresponds to a current sales floor demand of the product being evaluated at the time the product is being unloaded from the delivery and/or sorted during an unload process. The demand rating is utilized by the control circuit 202 in determining a priority of the product.

In some instances, the control circuit may confirm the demand rating of each of the one or more products has a predefined relationship with a corresponding sensitivity override threshold of the shopping facility. Again, one or more sensitivity override thresholds may be defined for a shopping facility and correspond to an available workforce and/or workload associated at least with the stocking and/or unloading of the delivered products to be performed at the shopping facility. In some embodiments, the control circuit 202 is configured to receive and/or identify an available workforce at the shopping facility to perform product stocking on the sales floor of the shopping facility of one or more products to be unloaded from the delivery vehicle. This workforce allocation information may, in some instances, be provided by the workforce allocation system 112. Further, demand rating is typically different for different products, yet multiple different demand ratings may have the predefined relationship with the sensitivity override threshold. The control circuit 202 and/or demand system 110 may utilize the workforce information to assign the sensitivity override threshold as a function of the available workforce. The one or more products can be associated with one of multiple priority tiers during an unloading process. The tiers can correspond with a determined demand of the product relative to the sensitivity override threshold and one or more demand thresholds. In some applications, the tiers correspond to how workforce is allocated in stocking products as and/or after the products are unloaded from the delivery vehicle and/or sorted and ready for stocking. Further, the assignment to a priority tier typically further takes into consideration whether the demand rating of the product has a predefined relationship relative to one or more product demand thresholds.

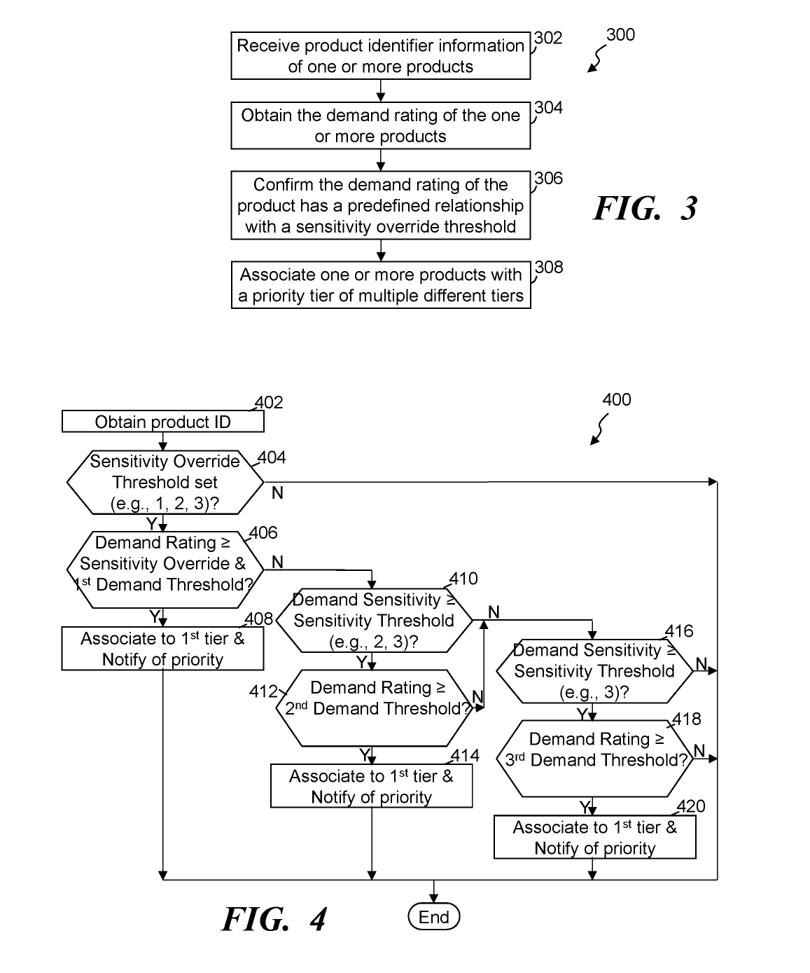

FIG. 3 illustrates a simplified flow diagram of a process 300 of prioritizing products being unloaded from a delivery vehicle at a shopping facility and providing a notification of product priority, in accordance with some embodiments. In step 302 product identifier and/or identifier information of one or more products being unloaded from the delivery vehicle is received, for example, from a product scanner system 104. In step 304, a demand rating of the one or more products being unloaded from the delivery vehicle is obtained. Typically, the demand rating of the one or more products corresponds to current sales floor demands of the products at the time the one or more products are being unloaded. Additionally, in some embodiments, the demand rating can be determined based one or more factors. These factors can include, but are not limited to, available shelf space assigned to the product (or rack space, or other such display location), remaining quantity of the product on the sales floor, recent sales, historic sales, predicted sales, predicted rates of sales, other such factors, or a combination of such factors. For example, some embodiments determine and/or obtain a predicted sales rate is for a product, and the demand rating of the product is specified as a function of the predicted sales rate.

Some embodiments in identifying the demand rating of a product may specify one of a set of demand ratings corresponding to one or more demand thresholds. In some applications, a demand rating is specified for one or more products to a first or out of stock demand level when a shelf demand on the sales floor in the shopping facility for the product is greater than or equal to a shelf capacity on the sales floor for a product being evaluated. Similarly, a demand rating of a product may be specified to be a second capacity demand level when the shelf demand of the product on the sales floor is greater than a shelf capacity threshold of the product. In some implementations, the shelf capacity threshold may be a percentage capacity. Further, the shelf capacity threshold may depend on a rate at which the product is selling and/or predicted sales. Some embodiments may further specify a demand rating of a product to be a third or case demand level when the shelf demand is predicted to be less than the shelf capacity threshold of the product and is further predicted to be equal to or greater than a full case of the product. Other demand ratings or levels may be specified based on one or more other thresholds and/or factors.

In step 306, the demand rating of the product is confirmed as having a predefined relationship with a sensitivity override threshold of the shopping facility that corresponds to a product stocking workload to be performed at the shopping facility. The sensitivity override threshold, in some applications, is a facility level threshold that can provide a filter of the determined demand ratings to more effectively focus the allocation of the available workforce to those products that are of highest priority. Further, the sensitivity override threshold may be dependent on workforce. As such, some embodiments identify an available workforce at the shopping facility that is or can be made available to perform product stocking on the sales floor of the shopping facility of the one or more products being unloaded from the delivery vehicle. The sensitivity override threshold can then be assigned as a function of the available workforce to perform the stocking. This can include identifying underutilized workers and increasing an available workforce as a function of the underutilization. Some embodiments additionally or alternatively consider one or more additional factors in assigning a sensitivity override threshold. For example, some embodiments assign the sensitivity override threshold as a function of one or more of a size of a total load of all products to be unloaded from the delivery vehicle, types of products in the total load, a statistical demand at the shopping facility, departments into which products are to be distributed, available workforce relative to different departments, and/or other such factors. As a further example, in some embodiments a statistical demand is received that is determined as a function of current demands of multiple different products available for purchase at the shopping facility. The sensitivity override threshold may then be assigned as a function of the statistical demand. Further, one or more weightings may be applied based on one or more of these factors.

In step 308, one or more products may be associated, during an unloading process, with a priority tier of multiple different tiers when the demand rating of the product being evaluated has the predefined relationship to the sensitivity override threshold and has a predefined relationship relative to a product demand threshold. Based on the priority tier one or more workers are then assigned to stock those products that have been associated with a tier that is greater than a tier threshold. Further, the order of stocking of the products may be specified according to a hierarchy of the tiers. Accordingly, the product prioritization system may associate each product that has the predefined relationship to the sensitivity override threshold and has a predefined relationship relative to a product demand threshold with one of multiple different tiers. Further, the product prioritization system and/or the workforce allocation system 112 can then direct workforce to pick products in a first tier and restock those products of the first tier. Should there be additional workforce available while or after the first tier of products has been stocked, products associated with a second tier can then be restocked. Subsequent tiers can similarly be restocked based on their priority relative to one or more other tiers.

Accordingly, multiple priority tiers can be assigned to different products with different demands. For example, some embodiments may receive identifier information for a first product and a second product being unloaded from the delivery vehicle and identify demand ratings for each of the first and second products corresponding to current sales floor demands of the first and second products at the time the products are being unloaded. The product priority system can confirm the demand rating of the first and second products have a predefined relationship with the sensitivity override threshold. When the demand ratings have the predefined relationship with the sensitivity override thresholds, the first product may be associated with a first priority tier of multiple potential priority tiers as a function of the demand rating of the first product when the demand rating of the first product has the predefined relationship to the sensitivity override threshold and has a predefined relationship relative to the first product demand threshold, and can associate the second product with a second priority tier of the multiple potential priority tiers as a function of the demand rating of the second product when the demand rating of the second product has the predefined relationship to the sensitivity override threshold and has a predefined relationship relative to a second product demand threshold that is different than the first product demand threshold. In some instances, a products demand rating may change during the unloading and/or restocking. As such, the prioritization may modify a products priority and/or the designated priority tier with which the product is associated. A notification can be communicated to the one or more workers regarding this modification.

In some embodiments, the sensitivity override threshold may be set by a worker (e.g., stock manager, store manager, etc.) that supersedes and/or overrides one or more previous sensitivity override thresholds. This allows workers with additional knowledge to which the priority system may not have access to specify a sensitivity override threshold. This can further allow a worker to modify a sensitivity override threshold where too many or not enough workers are being allocated. In some embodiments the product prioritization system 102 receives a sensitivity override threshold input from an individual authorized relative to the shopping facility to override a previous sensitivity override threshold. The product priority system can then set the sensitivity override threshold by overriding a sensitivity override threshold that is automatically determined by the control circuit 202 with the sensitivity override threshold input.

Similarly, a superseding sensitivity override threshold may be set for multiple different shopping facilities. This can force a sensitivity override threshold. This forced sensitivity override threshold may be used to evaluate shopping facility performance, force an allocation of workforce, force a scheduling of a workforce, and/or other such factors. In some embodiments, the product prioritization system 102 receives, at the control circuit, a global sensitivity override threshold communicated to and to be applied by each of multiple different shopping facilities. The sensitivity override threshold is then set to the global sensitivity override threshold that overrides a sensitivity override threshold determined by the product prioritization system for at least for a load of multiple products being delivered by the delivery vehicle.

FIG. 4 illustrates a simplified flow diagram of a process 400 of providing notification of product priority, in accordance with some embodiments. In step 402, product identifier information is received for one or more products as they are being unloaded from a delivery vehicle at the shopping facility. In some implementations this includes receiving a scan of a product identifier, a case identifier or the like from a scanner system. In step 404, it is determined whether the sensitivity override threshold is active. Typically, the sensitivity override threshold can be set to one of multiple different levels, with successive levels typically causing more products to be prioritized to be stocked. For example, a sensitivity override threshold set to “1” causes the greatest filtering and thus typically results in the fewest products being prioritized for stocking, while a “3” sensitivity override threshold allows an increased number of products to be prioritized for stocking. Accordingly, when the sensitivity override threshold is not active, the prioritization of products is not considered as they are unloaded from the sales vehicle. Further, in some embodiments the sensitivity override threshold typically is not dependent on a demand for a product, and instead is dependent on other factors. For example, the sensitivity override threshold may be determined based on one or more factors such as, but not limited to, a store level and/or statistical demand, a load level demand, a multi-store demand, a total load of all products to be unloaded from the delivery vehicle, types of product or products in the total load (e.g., could be temperature dependent products, cycled products, etc.), a statistical demand at the shopping facility, departments into which products are to be distributed, available workforce relative to different departments, an available workforce at the shopping facility and/or scheduled or predicted to be at the shopping facility, the work tasks already assigned to the workforce, scheduled work tasks, one or more priority levels of those previously assigned and/or scheduled tasks. Still further, the sensitivity override threshold is typically not specific to a single product or a small group of products, but instead is typically applied to a relatively large grouping and more typically is a global setting that is applied to all products. In some applications, the sensitivity override threshold corresponds to how aggressively products being unloaded are going to be forced to be picked and moved to the sales floor. Again, this typically is dependent on available workforce.

In step 406, it is determined whether a product demand rating for an identified product is greater than a first product demand threshold and the sensitivity override threshold set to a first sensitivity level that corresponds to a maximum limit on the number of products that are going to be prioritized to be immediately moved to the sales floor. Again, the maximum sensitivity override threshold may correspond to times when there are only a limited number of workers available to perform the stocking, other tasks are set as higher priority, or other such factors. As such, when the sensitivity override threshold is set to a highest level, fewer if any products are flagged to be moved out to the sales floor. Further, the first product demand threshold may correspond to the different levels of the sensitivity override threshold, and a maximum product demand threshold may correspond to a highest level of demand (e.g., the shelves reserved for the product being evaluated are empty or expected to be empty within a predicted amount of time). When the product demand rating has the predefined relationship with an initial or maximum product demand threshold and the sensitivity override threshold is actively being considered, the process advances to step 408 where the product is associated with a first priority tier and the one or more workers unloading are notified of the priority so that the worker can place the product at a priority location. Some embodiments additionally notify one or more workers to pick the priority product and a task can be assigned to restock that product.

In step 410, it is determined whether the product demand rating corresponds to and/or exceeds a second lower sensitivity override threshold, such that products are more likely to be designated has priority products for restocking. For example, the sensitivity override threshold may have three levels, and the evaluation in step 410 determines whether the sensitivity override threshold is set to one or levels 2 or 3. When the sensitivity override threshold is set the process advances to step 412 to determine whether a product demand rating for the product being unloaded is currently set to a second demand threshold, which is less than a first or maximum demand threshold, but is greater than at least a third demand threshold. For example, the second demand threshold may correspond to a threshold amount of the total shelf space reserved for the product being unloaded is empty and available to be restocked (e.g. 80% empty). When the product demand rating is greater than the second demand threshold the product is associated with a second tier in step 414 and the one or more workers unloading the product may be notified of the prioritized product for stocking so that the worker can place the product at a priority location. Some embodiments additionally assign a task to one or more workers to restock at least those tier two products.

In step 416, it is confirmed that the product demand rating corresponds to and/or exceeds at least a third sensitivity override threshold. When the demand rating corresponds to the third sensitivity override threshold, it is determined in step 418 whether the demand rating further exceeds a third demand threshold (e.g., the empty shelf space will receive at least a case). When the demand rating exceeds the third demand threshold the product is associated with a third tier in step 420 and one or more workers unloading the product are notified of the prioritized product for stocking so that the worker can place the product at a priority location. Some embodiments additionally assign a task to one or more workers to restock at least those tier two products. The process 400 may include additional similar steps for other sensitivity override thresholds and/or tier levels.

The notification to the worker unloading the product that the product has a threshold level of priority may be generated on the scanner the worker is using to scan a bar code or other identifier on the packaging of the product, may be communicated to a user interface unit (e.g., smart phone, tablet, etc.) that is carried by the worker, predefined lighting and/or sounds may be generate, or other such notification. For example, an audible alert may be generated, a notification can be displayed on a device display, one or more lights may be activated, other such notification, or combination of two or more of such notification. The notification, in some instances, may further distinguish between the different priority levels or tiers. Similarly, in some implementations the notification or a subsequent instruction may be provided to the one or more workers regarding what to do with the product and/or where to place the product. In response to the notification the worker or workers typically place the product at a predefined location. There may be different predefined locations for different priority tiers. Additionally or alternatively, in response to a first tier a worker may immediately take some or all of the unloaded first product out to the sales floor. Second tier products may be placed at a predefined location and/or into a predefined bin or cart. Similarly, other priority tiered products may be placed at similar priority locations and/or bins, carts or the like corresponding to the priority tier assigned to the product. As such, the locations, bins and/or carts provide an additional prioritization and can alert workers to the priority of products. Further, these prioritized organization of the products can help workers in identifying and selecting products to move to the sales floor consistent with assigned tasks.

In some embodiments, systems, apparatuses and methods are provided to enhance product stocking and the unloading of delivery vehicles. In some embodiments, systems provide notification of product priority, comprising: a product scanner system configured to scan a first product being unloaded from a delivery vehicle at a shopping facility, to obtain first product identifier information of the first product, and communicate the first product identifier information; a product prioritization system comprising a control circuit coupled to memory storing computer instructions that when executed by the control circuit cause the control circuit to: receive the first product identifier information of the first product being unloaded from the delivery vehicle; obtain a demand rating of the first product being unloaded from the delivery vehicle, wherein the demand rating of the first product corresponds to a current sales floor demand of the first product at the time the first product is being unloaded; confirm the demand rating of the first product has a predefined relationship with a sensitivity override threshold of the shopping facility that corresponds to a product stocking workload to be performed at the shopping facility; and associate, during an unloading process, the first product with a first priority tier when the demand rating of the first product has the predefined relationship to the sensitivity override threshold and has a predefined relationship relative to a first product demand threshold.

In some embodiments, methods of providing notification of product priority, comprise: by a control circuit of a product prioritization system: receiving, from a product scanner system, first product identifier information of the first product being unloaded from the delivery vehicle; obtaining a demand rating of a first product being unloaded from the delivery vehicle, wherein the demand rating of the first product corresponds to a current sales floor demand of the first product at the time the first product is being unloaded; confirming the demand rating of the first product has a predefined relationship with a sensitivity override threshold of the shopping facility that corresponds to a product stocking workload to be performed at the shopping facility; and associating, during an unloading process, the first product with a first priority tier when the demand rating of the first product has the predefined relationship to the sensitivity override threshold and has a predefined relationship relative to a first product demand threshold.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system providing notification of product priority, comprising:
a product scanner system configured to scan a first product being unloaded from a delivery vehicle at a shopping facility, to obtain first product identifier information of the first product, and communicate the first product identifier information;
a product prioritization system comprising a control circuit coupled to memory storing computer instructions that when executed by the control circuit cause the control circuit to:
receive the first product identifier information of the first product being unloaded from the delivery vehicle;
obtain a demand rating of the first product being unloaded from the delivery vehicle, wherein the demand rating of the first product corresponds to a current sales floor demand of the first product at the time the first product is being unloaded;
confirm the demand rating of the first product has a predefined relationship with a sensitivity override threshold of the shopping facility that corresponds to a product stocking workload to be performed at the shopping facility; and
associate, during an unloading process, the first product with a first priority tier when the demand rating of the first product has the predefined relationship to the sensitivity override threshold and has a predefined relationship relative to a first product demand threshold.

2. The system of claim 1, wherein the control circuit is further configured to identify an available workforce at the shopping facility to perform product stocking on a sales floor of the shopping facility of one or more products to be unloaded from the delivery vehicle, and assign the sensitivity override threshold as a function of the available workforce.

3. The system of claim 2, wherein the control circuit in assigning the sensitivity override threshold further assigns the sensitivity override threshold as a function of the available workforce and one or more of: a size of a total load of all products to be unloaded from the delivery vehicle, types of products in the total load, and a statistical demand at the shopping facility.

4. The system of claim 1, further comprising:
a product demand system in communication with the product prioritization system, and configured to identify a statistical demand determined as a function of current demands of multiple different products available for purchase at the shopping facility; and
wherein the control circuit is further configured to receive the statistical demand and assign the sensitivity override threshold as a function of the statistical demand.

5. The system of claim 1, wherein the control circuit is further configured to receive a sensitivity override threshold input from an individual authorized relative to the shopping facility to override a previous sensitivity override threshold, and to set the sensitivity override threshold by overriding the previous sensitivity override threshold automatically determined by the control circuit with the sensitivity override threshold input.

6. The system of claim 1, the control circuit is further configured to:
receive a global sensitivity override threshold that is communicated to and to be applied by each of multiple different shopping facilities; and
set the sensitivity override threshold to the global sensitivity override threshold and overriding a previous sensitivity override threshold set for a load of multiple products being delivered by the delivery vehicle.

7. The system of claim 1, wherein the control circuit is further configured to:
further comprising:
a demand system communicationally coupled with the control circuit and configured to:
specify the demand rating of the first product to a first demand level when a shelf demand on the sales floor in the shopping facility for the first product is greater than or equal to a shelf capacity on the sales floor for the first product;
specify the demand rating of the first product to a second demand level when the shelf demand of the first product on the sales floor is greater than a shelf capacity threshold of the first product; and
specify the demand rating of the first product to a third demand level when the shelf demand is predicted to be less than the shelf capacity threshold of the first product and is predicted to be greater than a full case of the first product.

8. The system of claim 1, wherein the control circuit is further configured to:
obtain a predicted sales rate of the first product and specify the demand rating of the first product as a function of the predicted sales rate.

9. The system of claim 1, the control circuit is further configured to:
obtain a demand rating of a second product being unloaded from the delivery vehicle, wherein the demand rating of the second product corresponds to a current sales floor demand of the second product at the time the second product is being unloaded;
confirm the demand rating of the second product has the predefined relationship with the sensitivity override threshold; and
wherein the control circuit in associating the first product with the first priority tier is further configured to associate the first product with the first priority tier of multiple potential priority tiers as a function of the demand rating of the first product when the demand rating of the first product has the predefined relationship to the sensitivity override threshold and has a predefined relationship relative to the first product demand threshold; and associate the second product with a second priority tier of the multiple potential priority tiers as a function of the demand rating of the second product when the demand rating of the second product has the predefined relationship to the sensitivity override threshold and has a predefined relationship relative to a second product demand threshold that is different than the first product demand threshold.

10. A method of providing notification of product priority, comprising:
by a control circuit of a product prioritization system:
receiving, from a product scanner system, first product identifier information of the first product being unloaded from the delivery vehicle;
obtaining a demand rating of a first product being unloaded from the delivery vehicle, wherein the demand rating of the first product corresponds to a current sales floor demand of the first product at the time the first product is being unloaded;
confirming the demand rating of the first product has a predefined relationship with a sensitivity override threshold of the shopping facility that corresponds to a product stocking workload to be performed at the shopping facility; and
associating, during an unloading process, the first product with a first priority tier when the demand rating of the first product has the predefined relationship to the sensitivity override threshold and has a predefined relationship relative to a first product demand threshold.

11. The method of claim 10, further comprising:
identifying an available workforce at the shopping facility to perform product stocking, on a sales floor of the shopping facility, of one or more products to be unloaded from the delivery vehicle; and
assigning, by the control circuit, the sensitivity override threshold as a function of the available workforce.

12. The method of claim 11, wherein the assigning the sensitivity override threshold further comprises assigning the sensitivity override threshold as a function of the available workforce and one or more of: a size of a total load of all products to be unloaded from the delivery vehicle, types of products in the total load, and a statistical demand at the shopping facility.

13. The method of claim 10, further comprising:
receiving a statistical demand determined as a function of current demands of multiple different products available for purchase at the shopping facility; and
assigning, by the control circuit, the sensitivity override threshold as a function of the statistical demand.

14. The method of claim 10, further comprising:
receiving a sensitivity override threshold input from an individual authorized relative to the shopping facility to override a previous sensitivity override threshold; and
setting the sensitivity override threshold by overriding a previous sensitivity override threshold automatically determined by the control circuit with the sensitivity override threshold input.

15. The method of claim 10, further comprising:
receiving, at the control circuit, a global sensitivity override threshold communicated to and to be applied by each of multiple different shopping facilities; and
setting the sensitivity override threshold to the global sensitivity override threshold and overriding a previous sensitivity override threshold set for a load of multiple products being delivered by the delivery vehicle.

16. The method of claim 10, further comprising:
identifying the demand rating of the first product comprising:
specifying the demand rating of the first product to a first demand level when a shelf demand on the sales floor in the shopping facility for the first product is greater than or equal to a shelf capacity on the sales floor for the first product;
specifying the demand rating of the first product to a second demand level when the shelf demand of the first product on the sales floor is greater than a shelf capacity threshold of the first product; and
specifying the demand rating of the first product to a third demand level when the shelf demand is predicted to be less than the shelf capacity threshold of the first product and is predicted to be greater than a full case of the first product.

17. The method of claim 10, further comprising:
obtaining a predicted sales rate of the first product and specifying the demand rating of the first product as a function of the predicted sales rate.

18. The method of claim 10, further comprising:
receiving product identifier information of a second product being unloaded from the delivery vehicle;
obtaining a demand rating of the second product corresponding to a current sales floor demand of the second product at the time the second product is being unloaded;
confirming the demand rating of the second product has the predefined relationship with the sensitivity override threshold; and
wherein the associating the first product with the first priority tier comprises associating the first product with the first priority tier of multiple potential priority tiers as a function of the demand rating of the first product when the demand rating of the first product has the predefined relationship to the sensitivity override threshold and has a predefined relationship relative to the first product demand threshold; and associating the second product with a second priority tier of the multiple potential priority tiers as a function of the demand rating of the second product when the demand rating of the second product has the predefined relationship to the sensitivity override threshold and has a predefined relationship relative to a second product demand threshold that is different than the first product demand threshold.
